(19) United States
(12) Patent Application Publication
(10) Pub. No.: US 2008/0199688 A1
(43) Pub. Date: Aug. 21, 2008

(54) Thermal Diffusion Sheet and Manufacturing Method of the Same

(75) Inventor: Motoki Ozawa, Yokohama-shi (JP)

Correspondence Address: CROMPTON, SEAGER & TUFTE, LLC, 1221 NICOLLET AVENUE, SUITE 800, MINNEAPOLIS, MN, 55403-2420, US

(73) Assignee: POLYMATECH CO., LTD., Tokyo (JP)

(21) Appl. No.: 12/027,466

(22) Filed: Feb. 7, 2008

(30) Foreign Application Priority Data
Feb. 15, 2007 (JP) 2007-034755

(51) Int. Cl. B32B 7/02; B32B 15/04; B05D 5/12

(52) U.S. Cl. 428/332; 428/457; 428/450; 427/58

(57) ABSTRACT

A thermal diffusion sheet is provided with a heat conducting layer, a thermal diffusion layer provided on the surface of the heat conducting layer and a heat insulating layer provided on the surface of the thermal diffusion layer. The heat conducting layer is formed of a composition containing an organic polymer and a heat conductive filler. The thermal diffusion layer is formed of a metal material. The heat insulating layer is formed of a material having electrical insulation properties. The thermal diffusion sheet is manufactured through providing a heat insulating layer on the surface of a thermal diffusion layer, preparing a composition, and forming a heat conducting layer. When preparing a composition, an organic polymer in liquid form having thermosetting properties and a heat conductive filler are mixed. When forming a heat conducting layer, the above described composition is applied to the surface of the thermal diffusion layer facing the surface on which the heat insulating layer has been provided, and after that, the composition is heated so that the organic polymer is cured.

### BACKGROUND OF THE INVENTION

The present invention relates to a thermal diffusion sheet which is used to diffuse heat generated by an electronic part, which is a heat emitting body, for example, a central processing unit (CPU) or an integrated circuit (IC), and to a manufacturing method for the same.

Conventional heat conductive sheets are used to diffuse heat from an electronic part, which is a heat emitting body, for example, a CPU or an IC. These heat conductive sheets are sandwiched between, for example, an electronic part and a heat sink or the housing so that the heat from the electronic part is diffused to the heat sink or the housing. In addition, heat conductive sheets are installed on, for example, an electronic part in such a state as to be at a distance from the housing so that the heat from the electronic part is diffused. Such heat conductive sheets are disclosed in Japanese Patent No. 3435097, Japanese Patent No. 3504882 and Japanese Patent No. 3712943.

In addition, a graphite sheet can be used as a heat conductive sheet. The heat conductivity of a graphite sheet in the direction parallel to the surfaces, that is to say, in the direction within the plane, is usually approximately 240 W/m·K to 400 W/m·K and is high in comparison with the heat conductivity of the graphite sheet in the direction of the thickness. Therefore, graphite sheets have high heat conductivity in the direction within the plane. However, graphite sheets have low strength and are fragile, and in addition, have conductivity. Therefore, in the case where a graphite sheet is broken within an electronic device, there is a risk that pieces of the graphite sheet may disperse, thereby damaging the electronic device.

### SUMMARY OF THE INVENTION

An objective of the present invention is to provide a thermal diffusion sheet which is more appropriate for use in applications where heat is diffused from a heat emitting body as well as a manufacturing method for the same.

To achieve the foregoing objective and in accordance with one aspect of the present invention, a thermal diffusion sheet having a heat conducting layer, a thermal diffusion layer, and a heat insulating layer is provided. The heat conducting layer is formed of a composition containing an organic polymer and a heat conductive filler. The thermal diffusion layer is provided on a surface of the heat conducting layer and formed of a metal material. The heat insulating layer is provided on a surface of the thermal diffusion layer and formed of a material having electrical insulation properties.

In accordance with another aspect of the present invention, a manufacturing method of a thermal diffusion sheet is provided, which has a heat conducting layer formed of a composition containing an organic polymer having thermosetting properties and a heat conductive filler, a thermal diffusion layer provided on a surface of the heat conducting layer and formed of a metal material, and a heat insulating layer provided on a surface of the thermal diffusion layer and formed of a material having electrical insulation properties. The method includes: providing a heat insulating layer on a surface of a thermal diffusion layer; preparing a composition by mixing an organic polymer in liquid form having thermosetting properties and a heat conductive filler; and forming a heat conducting layer by applying the composition onto a surface of the thermal diffusion layer facing the surface on which the heat insulating layer has been provided, and after that, heating the composition so that the organic polymer is cured.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing a thermal diffusion sheet according to one embodiment; and

FIG. 2 is a cross-sectional view showing a container.

### DETAILED DESCRIPTION OF THE PREFERRED EMBODIMENTS

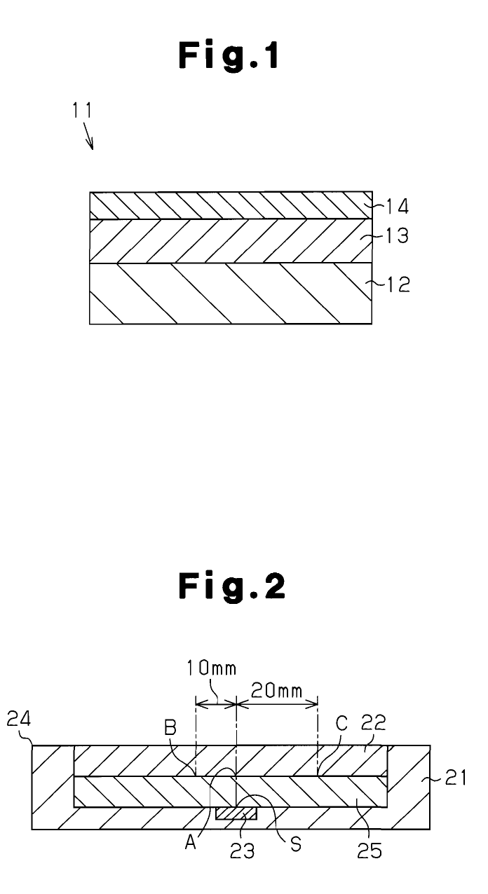

In the following, a thermal diffusion sheet according to an embodiment of the present invention is described in detail in reference to the drawings. As shown in FIG. 1, the thermal diffusion sheet 11 according to the present embodiment is provided with a heat conducting layer 12, a thermal diffusion layer 13 laminated on the surface of the heat conducting layer 12, and a heat insulating layer 14 laminated on the surface of the thermal diffusion layer 13. The thermal diffusion sheet 11 is installed, for example, on an electronic part, which is a heat emitting body within an electronic device, so as to diffuse the heat generated by the electronic part, and thus, prevent the heat from being accumulated within the electronic part and in the vicinity thereof.

The heat conducting layer 12 conducts heat from the heat emitting body to the thermal diffusion layer 13. The heat conducting layer 12 is formed of a composition containing an organic polymer and a heat conductive filler. The heat conducting layer 12 makes close contact with the heat emitting body when the thermal diffusion sheet 11 is installed on the heat emitting body so as to lower the value of the contact thermal resistance due to the properties of the organic polymer.

The organic polymer preferably makes the heat conducting layer 12 an elastic body in rubber form or makes the heat conducting layer 12 be in a gel or grease form. In this case, the heat conducting layer 12 can make close contact with the heat emitting body without creating a gap in-between, and thus, greatly lower the value of the contact thermal resistance. In addition, in order that form the heat conducting layer 12 can be easily formed at the time of the manufacture of the thermal diffusion sheet 11, the organic polymer preferably has thermosetting properties. Silicone-based resins, urethane-based resins, olefin-based resins and rubber may be used as an organic polymer having thermosetting properties. As the form of the organic polymer having thermosetting properties, gel may be used.

As the material of the heat conductive filler, metal oxides, metal nitrides, metal carbides and metal hydroxides may be used, and specifically, aluminum oxide, boron nitride, silicon carbide and aluminum hydroxide may be used. The form of the heat conductive filler is not particularly limited and may be in powder form, granular form or fiber form.

The thickness of the heat conducting layer 12 is preferably 100 μm or less, and more preferably, 90 μm or less. In the case where the thickness of the heat conducting layer 12 exceeds 100 μm, the heat conducting layer 12 is excessively thick, and therefore, there is a risk that the value of the thermal resistance of the heat conducting layer 12 may become high. The lower limit of the thickness of the heat conducting layer 12 is not particularly limited. The heat conducting layer 12 is formed throughout the entirety of the thermal diffusion layer 13.

The thermal diffusion layer 13 diffuses the heat that has been conducted from the heat emitting body via the heat conducting layer 12. The thermal diffusion layer 13 is formed of a metal material. The thermal diffusion layer 13 is preferably formed of a metal material having high heat conductivity, so that the thermal diffusion layer 13 has high thermal diffusion properties. As the metal material of which the thermal diffusion layer 13 is formed, copper, aluminum, iron and stainless steel may be used. In addition, as the metal material of which the thermal diffusion layer 13 is formed, alloys, for example, copper alloys and aluminum alloys, may be used. The purity of the metal, for example, the purity of copper, is preferably high because of the high heat conductivity. As copper having high purity, tough pitch copper and oxygen free copper may be used. The purity of copper in tough pitch copper and oxygen free copper is 99.9% or higher. The heat conductivity of copper having high purity is 401 W/m·K, the heat conductivity of aluminum is 237 W/m·K, the heat conductivity of iron is 80 W/m·K and the heat conductivity of SUS 304 stainless steel is 15 W/m·K.

The thickness of the thermal diffusion layer 13 is preferably 10 μm or higher, and more preferably 30 μm to 110 μm. When the thickness of the thermal diffusion layer 13 is less than 10 μm, there is a risk that the heat capacity of the thermal diffusion layer 13 may be saturated in the case where the amount of heat emitted by the heat emitting body is great. Even when the thickness of the thermal diffusion layer 13 exceeds 110 μm, the thermal diffusion layer 13 cannot increase the level of the thermal diffusion properties to be higher than that.

The thermal conductance of the thermal diffusion layer 13 has isotropy due to the properties of the metal material which forms the thermal diffusion layer 13. Therefore, the heat insulating layer 14 is laminated on the thermal diffusion layer 13, and thus, the thermal conductance through the thermal diffusion layer 13 in the direction of the thickness is blocked by the border between the thermal diffusion layer 13 and the heat insulating layer 14 so that the heat conductivity of the thermal diffusion layer 13 in the direction within the plane is increased. The heat insulating layer 14 is formed throughout the entirety of the thermal diffusion layer 13. Thus, the heat insulating layer 14 covers the surface of the thermal diffusion layer 13 so as to prevent the thermal diffusion layer 13, which has conductivity due to the properties of the metal material, and a member within the electronic device other than the thermal diffusion sheet 11 from making contact and provide electrical insulation properties to the thermal diffusion sheet 11.

The heat insulating layer 14 is formed of a material having electrical insulation properties. As the material of the heat insulating layer 14, polyethylene terephthalate (PET), polyethylene naphthalate (PEN), polyphenylene sulfide (PPS), polyethylene (PE), polypropylene (PP), polyimide (PI), polycarbonate (PC), silicone resins, and urethane resins may be used. As the silicone resins, silicone rubber may be used.

It is preferable that the thermal conductivity of the heat insulating layer 14 be as low as possible. Specifically the thermal conductivity is preferably 0.5 W/m·K or lower, and more preferably 0.2 W/m·K or lower. The heat conductivity of PET and PI is approximately 0.15 W/m·K, the heat conductivity of PP is approximately 0.12 W/m·K, the heat conductivity of PC is approximately 0.19 W/m·K, the heat conductivity of PE is approximately 0.50 W/m·K and the heat conductivity of PPS is approximately 0.29 W/m·K. Therefore, PET, PP, PI and PC, from among the above described examples, are preferable.

The thickness of the heat insulating layer 14 is preferably 10 μm to 100 μm. In the case where the thickness of the heat insulating layer 14 is less than 10 μm, the thermal conductance of the thermal diffusion layer 13 in the direction of the thickness cannot be sufficiently blocked, and thus, the heat conductivity of the thermal diffusion layer 13 in the direction within the plane cannot be sufficiently increased. In the case where the thickness of the heat insulating layer 14 exceeds 100 μm, heat is accumulated between the thermal diffusion layer 13 and the heat insulating layer 14, and there is a risk that the heat may not be diffused from the surface of the thermal diffusion sheet 11.

Next, a manufacturing method for the thermal diffusion sheet 11 is described. In the following description, the organic polymer which forms the heat conducting layer 12 has thermosetting properties. The thermal diffusion sheet 11 is manufactured through providing the heat insulating layer 14 on the surface of the thermal diffusion layer 13, preparing the above described composition, and forming the heat conducting layer 12 on the surface of the thermal diffusion layer 13.

When providing the heat insulating layer 14 on the surface of the thermal diffusion layer 13, the heat insulating layer 14 in film form is laminated on the surface of the thermal diffusion layer 13. When preparing the above described composition, an organic polymer in liquid form having thermosetting properties and a heat conductive filler are mixed so that the composition is prepared. When forming the heat conducting layer 12 on the surface of the thermal diffusion layer 13, the above described composition is applied onto the surface of the thermal diffusion layer 13 facing the surface on which the heat insulating layer 14 has been laminated. Next, the composition is heated and the organic polymer is cured, and thus, the heat conducting layer 12 is formed. The order of the providing of the heat insulating layer 14 on the surface of the thermal diffusion layer 13 and the preparing the above described composition is not particularly limited. In addition, the preparing of the above described composition and the forming of the heat conducting layer 12 on the surface of the thermal diffusion layer 13 may be carried out before the providing of the heat insulating layer 14 on the surface of the thermal diffusion layer 13.

The above described embodiment has the following advantages.

The thermal diffusion sheet 11 according to the present embodiment is provided with the heat conducting layer 12 and the heat insulating layer 14 in addition to the thermal diffusion layer 13. Therefore, the value of the contact thermal resistance between the thermal diffusion sheet 11 and the heat emitting body is lowered due to the use of the heat conducting layer 12 so that the thermal conductance from the heat emitting body to the thermal diffusion layer 13 is accelerated. Additionally, the thermal diffusion properties of the thermal diffusion layer 13 in the direction within the plane are enhanced due to the use of the heat insulating layer 14. Thus, the thermal diffusion properties of the thermal diffusion sheet 11 are enhanced. In addition, the heat insulating layer 14 is formed of a material having electrical insulation properties, and the surface of the thermal diffusion layer 13 is covered with the heat insulating layer 14. Therefore, the thermal diffusion sheet 11 has high electrical insulation properties.

In the manufacture of the thermal diffusion sheet 11 according to the present embodiment, the above described heat conducting layer 12 is formed by heating the above described composition after the composition has been applied onto the surface of the thermal diffusion layer 13. Therefore, the heat conducting layer 12 having an organic polymer and a heat conductive filler can be easily laminated on the thermal diffusion layer 13, and thus, the thermal diffusion sheet 11 can be easily manufactured.

It should be apparent to those skilled in the art that the present invention may be embodied in many other specific forms without departing from the spirit or scope of the invention. Particularly, it should be understood that the invention may be embodied in the following forms.

The above described heat insulating layer 14 may have an outer shape which is greater than that of the thermal diffusion layer 13. In this case, the heat insulating layer 14 covers the end portions of the thermal diffusion layer 13, and therefore, electrical insulation properties is provided to the thermal diffusion sheet 11 without fail.

In the manufacture of the above described thermal diffusion sheet 11, the heat insulating layer 14 may be formed by preparing the composition for forming the heat insulating layer 14, applying this composition onto the surface of the thermal diffusion layer 13, and then curing the composition.

The above described heat conducting layer 12 may be formed only in a portion of the thermal diffusion layer 13. In this case, the heat conducting layer 12 is formed in the portion of the thermal diffusion layer 13 corresponding to the heat emitting body. In addition, the above described heat insulating layer 14 may be formed only in a portion of the thermal diffusion layer 13.

Next, the above described embodiment is described more concretely by citing examples and comparative examples.

### Example 1

In Example 1, a heat insulating layer 14 made up of a PET film having a thickness of 25 μm was laminated on the surface of a thermal diffusion layer 13 made up of a copper foil having a thickness of 35 μm. At this time, the thermal diffusion layer 13 and the heat insulating layer 14 were laminated while being heated. In addition, 100 parts by weight of a two-component silicone resin in liquid form, which is an organic polymer having thermosetting properties, 600 parts by weight of aluminum oxide in spherical form and 200 parts by weight of a single crystal powder of aluminum oxide, which are heat conductive fillers, 50 parts by weight of a two-component silicone-based adhesive and 0.05 parts by weight of a platinum catalyst were kneaded by a planetary mixer, and thus, a composition was prepared.

Next, the above described composition was applied onto the surface of the thermal diffusion layer 13 facing the surface on which the heat insulating layer 14 was laminated. Subsequently, the composition was heated at 80° C. for 20 minutes using hot wind and a far-infrared curing furnace so that the silicone resin in the composition was cured and the heat conducting layer 12 was formed, and thus, the thermal diffusion sheet 11 was gained. The thickness of the heat conducting layer 12 was 90 μm.

### Examples 2 to 10

In Examples 2 to 10, the thermal diffusion sheet 11 was gained in the same manner as in Example 1, except that the materials and the thicknesses of the thermal diffusion layer 13 and the heat insulating layer 14 were changed as shown in Table 1.

### Comparative Example 1

In Comparative Example 1, a sheet was gained in the same manufacturing process as in Example 1, except that the heat conducting layer 12 was omitted and the thicknesses of the thermal diffusion layer 13 and the heat insulating layer 14 were changed as shown in Table 1.

### Comparative Example 2

In Comparative Example 2, a sheet was gained in the same manufacturing process as in Example 1, except that the heat conducting layer 12 was formed of a two-sided tape having a thickness of 20 μm and the thicknesses of the thermal diffusion layer 13 and the heat insulating layer 14 were changed as shown in Table 1. The two-sided tape was formed of a base in sheet form and an adhesive applied to the two surfaces of the base and contained no heat conductive filler.

### Comparative Example 3

In Comparative Example 3, a sheet was gained in the same manufacturing process as in Example 1, except that the thermal diffusion layer 13 was formed of a graphite sheet having a thickness of 127 μm, and furthermore, the thickness of the heat insulating layer was changed to 5 μm.

### Comparative Example 4

In Comparative Example 4, a sheet was gained in the same manufacturing process as in Example 1, except that the thickness of the thermal diffusion layer 13 was changed to 70 μm, and furthermore, the heat insulating layer 14 was omitted.

Thus, the thermal diffusion sheet 11 in each example and the sheet in each comparative example were measured or evaluated based on each of the following items. The results are shown in Table 1.

<Temperature 10 Minutes after the Start of Heating Using Ceramic Heater>

Test pieces of which the longitudinal and lateral length is 100 mm were prepared from the thermal diffusion sheet 11 in each example and from the sheet in each comparative example. In addition, as shown in FIG. 2, a container 24 that was provided with a body 21 in cylindrical form having a bottom, a lid 22 for closing the opening created in the upper portion of the body 21 and a ceramic heater 23, which was a heat emitting body provided at the bottom of the body 21, was prepared. The body 21 and the lid 22 were formed of a heat insulating material. Next, a test piece 25 was placed into the body 21, and after that, the opening of the body 21 was closed with the lid 22. At this time, the ceramic heater 23 was exposed from the bottom of the body 21 and made contact with the test piece 25.

Next, thermal couples were installed in a predetermined location on the ceramic heater 23 (hereinafter, referred to as point S), a location on the surface of the test piece 25 facing the lid 22 and corresponding to the ceramic heater 23 (hereinafter, referred to as point A), a location at a distance of 10 mm from point A to a side (hereinafter, referred to as point B), and a location at a distance of 20 mm from point A in the direction opposite to point B (hereinafter, referred to as point C). Then, the test piece 25 was heated with the ceramic heater 23 in a state where a load of 0.49 kPa (5 gf/cm²) was applied from above to the test piece 25 via the lid 22. Then, the temperatures at point S, point A, point B and point C were measured using the above described thermal couples 10 minutes after heating with the ceramic heater 23. In the column “temperature (° C.) after 10 minutes” of Table 1, the column “point S” shows the results of measurement of the temperature at point S, the column “point A” shows the results of measurement of the temperature at point A, the column “point B” shows the results of measurement of the temperature at point B, and the column “point C” shows the results of measurement of the temperature at point C.

### <Thermal Diffusion Properties>

Thermal diffusion properties of the thermal diffusion sheet 11 in each example and the sheet in each comparative example were evaluated using the temperatures at points S, B and C, which were measured as described above. Concretely, the difference between the results of measurement of the temperature at point S and the results of measurement of the temperature at each point, point B and point C, was calculated. In the column “thermal diffusion properties” of Table 1, the column “S-B” shows the difference in the temperature between point S and point B, and the column “S-C” shows the difference in the temperature between point S and point C.

TABLE 1

| | Heat conducting | | Thermal diffusion | | Heat insulating | | Temperature after | | | | Thermal | |
|---|---|---|---|---|---|---|---|---|---|---|---|---|
| | layer | | layer | | layer | | 10 minutes (° C.) | | | | diffusion | |
| | | Thickness | | Thickness | | Thickness | Point | Point | Point | Point | properties | |
| | Configuration | (μm) | Material | (μm) | Material | (μm) | S | A | B | C | S − B | S − C |
| Example 1 | Heat conducting layer | 90 | Copper | 35 | PET | 25 | 68 | 66 | 48 | 34 | 20 | 34 |
| Example 2 | Heat conducting layer | 90 | Aluminum | 30 | PET | 50 | 73.5 | 69.1 | 46.6 | 40.3 | 26.9 | 33.2 |
| Example 3 | Heat conducting layer | 90 | Copper | 18 | PET | 25 | 70.0 | 69.1 | 49.7 | 36.6 | 20.3 | 33.4 |
| Example 4 | Heat conducting layer | 90 | Copper | 18 | PET | 50 | 72.5 | 67.6 | 47.5 | 38.4 | 25.0 | 34.1 |
| Example 5 | Heat conducting layer | 90 | Copper | 70 | PET | 50 | 46.8 | 43.4 | 37.0 | 33.1 | 9.8 | 13.7 |
| Example 6 | Heat conducting layer | 90 | Copper | 35 | PET | 50 | 68 | 64 | 48 | 36 | 20 | 32 |
| Example 7 | Heat conducting layer | 90 | Copper | 70 | PET | 16 | 50 | 44 | 38 | 34 | 12 | 17 |
| Example 8 | Heat conducting layer | 90 | Copper | 70 | PET | 100 | 46 | 38 | 35 | 34 | 11 | 12 |
| Example 9 | Heat conducting layer | 90 | Copper | 105 | PP | 50 | 45 | 40 | 37 | 33 | 8 | 12 |
| Example 10 | Heat conducting layer | 90 | Aluminum | 50 | PP | 50 | 70 | 65 | 49 | 42 | 21 | 28 |
| Comparative | None | — | Copper | 70 | PET | 50 | 62.4 | 45.9 | 39.3 | 36.7 | 23.1 | 25.7 |
| Example 1 | | | | | | | | | | | | |
| Comparative | Two-sided tape | 20 | Copper | 70 | PET | 50 | 67.0 | 37.7 | 35.3 | 29.9 | 31.7 | 37.1 |
| Example 2 | | | | | | | | | | | | |
| Comparative | Heat conducting layer | 90 | Graphite | 127 | PET | 5 | 45.6 | 42.6 | 36.9 | 34.4 | 8.7 | 11.2 |
| Example 3 | | | | | | | | | | | | |
| Comparative | Heat conducting layer | 90 | Copper | 70 | None | — | 53 | 45 | 39 | 34 | 14 | 19 |
| Example 4 | | | | | | | | | | | | |

As shown in Table 1, in the thermal diffusion sheet 11 in each example, the temperature at point S 10 minutes after heating with the ceramic heater 23 was low, and the difference in the temperature between point S and each point, point B and point C, was small. Therefore, it was found out that the thermal diffusion sheet 11 in each example effectively diffused the heat from the ceramic heater 23.

It was found out that from the results of each item in Examples 4 to 6 that the heat from the ceramic heater 23 was diffused more effectively as the thickness of the thermal diffusion layer 13 increased. It was found out that from the results of measurement of the temperature at point S in Examples 5, 7, and 8 that the heat from the heat emitting body was more effectively diffused so that the heat emitting body was cooled more as the thickness of the heat insulating layer 14 increased.

Furthermore, it was found out that from the results of each item in Examples 5, 8 and 9 that the thermal diffusion sheet 11 in Examples 5, 8 and 9 had approximately the same degree of thermal diffusion properties as well-known graphite sheets, which have high thermal diffusion properties. Moreover, it was found out that that the thermal diffusion sheet 11, particularly in Examples 5, 8 and 9 from among the examples, decreased the number of heat spots in the thermal diffusion sheet 11. Heat spots are spots which become hot in comparison with other portions in electronic devices, such as cellular phones and laptop computers, and have a risk that the user of the electronic device may experience a low temperature burn. In addition, the thermal diffusion sheet 11 in each example had electrical insulation properties because the surface of the thermal diffusion layer 13 was covered with the heat insulating layer 14.

In contrast, in Comparative Example 1, the heat conducting layer 12 was omitted, and therefore, the thermal diffusion properties were inferior to those of Example 5 having the same configuration for the thermal diffusion layer 13 and the heat insulating layer 14. In Comparative Example 2, the heat conducting layer 12 did not contain a heat conductive filler, and therefore, the thermal diffusion properties were inferior to those of Example 5 having the same configuration for the thermal diffusion layer 13 and the heat insulating layer 14. In Comparative Example 3, the thermal diffusion layer 13 was formed of a graphite sheet, and thus, high thermal diffusion properties were provided. However, the thermal diffusion sheet was easily damaged because of the fragility of the graphite sheet. In Comparative Example 4, the heat insulating layer 14 was omitted, and therefore, the thermal diffusion properties were inferior to those of Examples 5 to 8 having the same configuration for the heat conducting layer 12 and the thermal diffusion layer 13. Judging from the above, the thermal diffusion sheet 11 in each example was appropriate for use in applications where heat is diffused from a heat emitting body in comparison with the sheet in each comparative example.

Therefore, the present examples and embodiments are to be considered as illustrative and not restrictive and the invention is not to be limited to the details given herein, but may be modified within the scope and equivalence of the appended claims.

What is claimed is:

1. A thermal diffusion sheet comprising:
a heat conducting layer formed of a composition containing an organic polymer and a heat conductive filler;
a thermal diffusion layer which is provided on a surface of the heat conducting layer and formed of a metal material; and
a heat insulating layer which is provided on a surface of the thermal diffusion layer and formed of a material having electrical insulation properties.

2. The thermal diffusion sheet according to claim 1, wherein the metal material is copper or aluminum.

3. The thermal diffusion sheet according to claim 1, wherein the material having electrical insulation properties is polyethylene terephthalate or polypropylene.

4. The thermal diffusion sheet according to claim 1, wherein the organic polymer is a silicone resin and the material of the heat conductive filler is aluminum oxide.

5. The thermal diffusion sheet according to claim 1, wherein the thickness of the heat conducting layer is 100 μm or less.

6. The thermal diffusion sheet according to claim 1, wherein the thickness of the thermal diffusion layer is 10 μm or greater.

7. The thermal diffusion sheet according to claim 1, wherein the thickness of the thermal diffusion layer is 30 μm to 110 μm.

8. The thermal diffusion sheet according to claim 1, wherein the thermal conductivity of the heat insulating layer is 0.5 W/m·K or lower.

9. The thermal diffusion sheet according to claim 1, wherein the thickness of the heat insulating layer is 10 μm to 100 μm.

10. The thermal diffusion sheet according to claim 1, wherein the heat conducting layer and the heat insulating layer are formed throughout the entirety of the thermal diffusion layer.

11. A manufacturing method of a thermal diffusion sheet provided with a heat conducting layer formed of a composition containing an organic polymer having thermosetting properties and a heat conductive filler, a thermal diffusion layer provided on a surface of the heat conducting layer and formed of a metal material, and a heat insulating layer provided on a surface of the thermal diffusion layer and formed of a material having electrical insulation properties, comprising:
providing a heat insulating layer on a surface of a thermal diffusion layer;
preparing a composition by mixing an organic polymer in liquid form having thermosetting properties and a heat conductive filler; and
forming a heat conducting layer by applying the composition onto a surface of the thermal diffusion layer facing the surface on which the heat insulating layer has been provided, and after that, heating the composition so that the organic polymer is cured.
